(19) United States
(12) Patent Application Publication
(10) Pub. No.: US 2015/0147092 A1
(43) Pub. Date: May 28, 2015

(54) IMAGE FORMING APPARATUS

(71) Applicant: FUJI XEROX CO., LTD., Tokyo (JP)

(72) Inventor: Kazuyoshi HAGIWARA, Kanagawa (JP)

(73) Assignee: FUJI XEROX CO., LTD., Tokyo (JP)

(21) Appl. No.: 14/271,615

(22) Filed: May 7, 2014

(30) Foreign Application Priority Data
Nov. 28, 2013 (JP) 2013-245546

(51) Int. Cl. G03G 15/16

(52) U.S. Cl. CPC G03G 21/1623
USPC 399/121

(57) ABSTRACT

Provided is an image forming apparatus including an apparatus body, an opening and closing member that is provided to be opened and closed with respect to the apparatus body, and a toner image holding unit that is configured such that an image holding member holding toner images formed by plural toner image forming units is movable between a first contact position at which the image holding member comes into contact with all toner image forming units and a second contact position at which the image holding member comes into contact with at least one of the toner image forming units, wherein when the opening and closing member is opened with respect to the apparatus body or when a power supply supplying power to the apparatus body is disconnected, the image holding member moves to the second contact position.

### CROSS-REFERENCE TO RELATED APPLICATIONS

This application is based on and claims priority under 35 USC 119 from Japanese Patent Application No. 2013-245546 filed Nov. 28, 2013.

### BACKGROUND

### Technical Field

The present invention relates to an image forming apparatus.

### SUMMARY

According to an aspect of the invention, there is provided an image forming apparatus including:

an apparatus body;

an opening and closing member that is provided to be opened and closed with respect to the apparatus body; and

a toner image holding unit that is configured such that an image holding member holding toner images formed by plural toner image forming units is movable between a first contact position at which the image holding member comes into contact with all toner image forming units and a second contact position at which the image holding member comes into contact with at least one of the toner image forming units,

wherein when the opening and closing member is opened with respect to the apparatus body or when a power supply supplying power to the apparatus body is disconnected, the image holding member moves to the second contact position.

### BRIEF DESCRIPTION OF THE DRAWINGS

Exemplary embodiments of the present invention will be described in detail based on the following figures, wherein:

FIG. 1 is a cross-sectional schematic diagram illustrating an example of a schematic configuration of an image forming apparatus;

FIG. 2 is a schematic diagram for illustrating a unit configuration in the image forming apparatus;

FIG. 3A is a schematic diagram illustrating a state where an image forming unit frame is drawn from a body, and FIG. 3B is a schematic diagram illustrating a state where a belt unit frame is drawn from the body;

FIG. 4 is a perspective view for illustrating an internal structure of a transfer unit;

FIG. 5A is a plan view for illustrating the internal structure of the transfer unit, and FIG. 5B is a front view for illustrating the internal structure of the transfer unit;

FIG. 6 is a cross-sectional schematic diagram for illustrating a contacting and separating structure of the transfer unit;

FIG. 7A is a cross-sectional schematic diagram illustrating a state where the transfer unit comes into contact with a photoconductor unit at the time of a full color printing, FIG. 7B is a cross-sectional schematic diagram illustrating a state where the transfer unit comes into contact with the photoconductor unit at the time of a monochrome printing, and FIG. 7C is a cross-sectional schematic diagram illustrating a state where the transfer unit is separated from the photoconductor unit;

FIG. 8 is a block diagram of a mode switching drive portion; and

FIG. 9 is a flowchart for illustrating a movement of the transfer unit toward a maintenance position.

### DETAILED DESCRIPTION

Next, the present invention will be described in detail according to the following exemplary embodiments and specific examples with reference to the drawings. However, the present invention is not limited to the exemplary embodiments and the specific examples.

Moreover, although it is described with reference to the following drawings, the drawings are only schematic, and thus, it should be noted that a ratio of each dimension or the like is different from the actual ones. Moreover, for ease of understanding, illustrations of members other than a member necessary for descriptions are appropriately omitted.

In addition, in order to easily understand the following description, in the drawings, a front-rear direction is set to an X axis direction, a right-left direction is set to a Y axis direction, and an up-down direction is set to a Z axis direction.

(1) Overall Configuration and Operation of Image Forming Apparatus

(1.1) Overall Configuration of Image Forming Apparatus

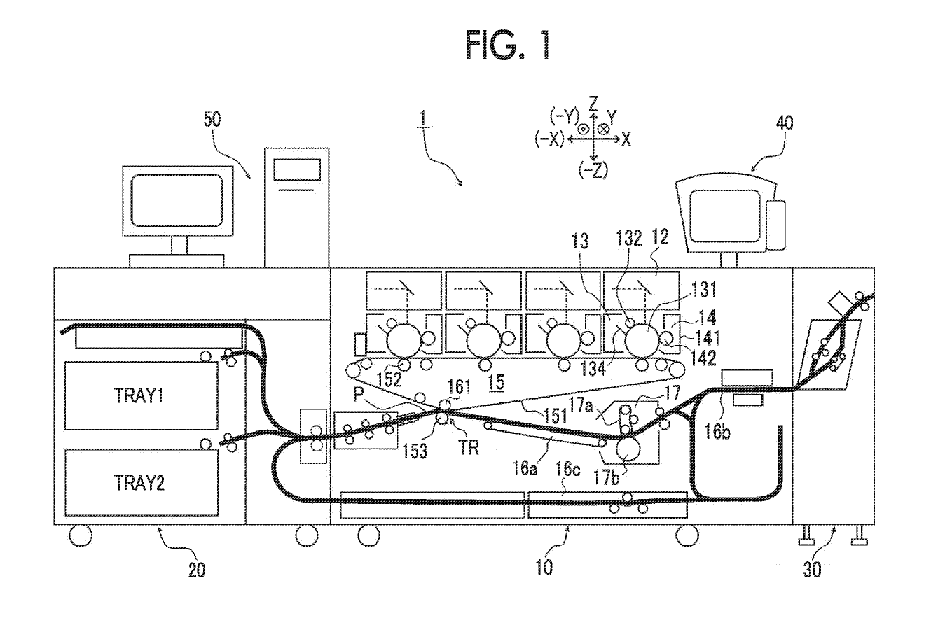

FIG. 1 is a cross-sectional schematic diagram illustrating an example of a schematic configuration of an image forming apparatus according to the present exemplary embodiment.

An image forming apparatus 1 is configured to include an image forming portion 10, a sheet feeding device 20 that is mounted on one end of the image forming portion 10, a sheet discharging portion 30 that is mounted on the other end of the image forming portion 10 and discharges a printed sheet, an operation information portion 40, and an image processing portion 50 that generates an graphic image from printing information sent from master equipment.

The image forming portion 10 is configured to include a system control device 11 (not illustrated in FIG. 1), an exposure device 12, a photoconductor unit 13, a developing device 14, a transfer unit 15, sheet transport devices 16a, 16b, and 16c, a fixing device 17, and a power supply device 18 (not illustrated in FIG. 1), and forms the image information received from the image processing portion 50 on a sheet P fed from the sheet feeding device 20, as a toner image.

The sheet feeding device 20 supplies the sheet to the image forming portion 10. That is, the sheet feeding device 20 includes plural trays that accommodate different kinds (for example, a material, a thickness, a sheet size, or a sheet texture) of sheets P, and is configured to supply the sheet P fed from any one of the plural trays to the image forming portion 10.

The sheet discharging portion 30 discharges the sheet P on which an image output is performed in the image forming portion 10. Accordingly, the sheet discharging portion 30 includes a discharging tray to which the sheet P subjected to the image output is discharged. Moreover, the sheet discharging portion 30 may have a function that performs post processing such as cutting or stapling (needle binding) on a sheet bundle output from the image forming portion 10.

The operation information portion 40 is provided on the image forming portion 10. The operation information portion 40 is used for input of various settings or instructions and for displaying information. That is, the operation information portion corresponds to a so-called user interface, and specifically, is configured to combine a liquid crystal display panel, various operation buttons, a touch panel, or the like.

(1.2) Configuration and Operation of Image Forming Portion

In the image forming apparatus 1 having the above-described configuration, the sheet P, which is fed from the tray that is designated for each sheet of the printing in a printing job in the sheet feeding device 20 in accordance with the timing of the image formation, is fed to the image forming portion 10.

The photoconductor units 13 are provided in parallel below (in −Z direction) the exposure device 12, and each of the photoconductor units includes a photoconductor drum 131 as an image holding member that is rotationally driven. A charging roller 132, the exposure device 12, the developing device 14, a primary image transfer roller 152, and a cleaning blade 134 are placed along a rotation direction of the photoconductor drum 131.

The developing device 14 includes a developer housing 141 that accommodates a developer in the inner portion. A developing roller 142 placed to oppose the photoconductor drum 131 is provided in the developer housing 141, and a layer regulating member (not illustrated) that regulates a layer thickness of the developer is placed to be close to the developing roller 142.

The respective developing devices 14 are configured to be similar to one another except for the developer that is accommodated in the developer housing 141, and form toner images of yellow (Y), magenta (M), cyan (C), and black (K), respectively.

The surface of the rotated photoconductor drum 131 is charged by the charging roller 132, and an electrostatic latent image is formed on the surface by latent image forming light emitted from the exposure device 12. The electrostatic latent image formed on the photoconductor drum 131 is developed as the toner image by the developing roller 142.

The transfer unit 15 includes an intermediate image transfer belt 151 that is an image holding member on which respective color toner images formed on the photoconductor drums 131 of respective photoconductor units 13 are multi-transferred, primary image transfer rollers 152(Y), 152(M), 152(C), and 152(K) that sequentially transfer (perform primary image transfer) respective color toner images formed on respective photoconductor units 13 to the intermediate image transfer belt 151, a secondary image transfer roller 153 that collectively transfers (performs secondary image transfer) respective color toner images transferred to be superimposed on the intermediate image transfer belt 151 to the sheet which is a recording medium, and a backup roller 161 that is placed to oppose the secondary image transfer roller 153 and to which a transfer voltage is applied.

The respective color toner images formed on the photoconductor drums 131 of respective photoconductor units are sequentially electrostatically transferred (are subject to primary image transfer) to the intermediate image transfer belt 151 by the primary image transfer roller 152 to which a predetermined transfer voltage is applied from the power supply device 18 controlled by the system control device 11, and thus, a superimposed toner image, on which respective color toners are superimposed, is formed.

The superimposed toner image on the intermediate image transfer belt 151 is transported to a region (secondary image transfer portion TR), at which the secondary image transfer roller 153 is placed, according to the movement of the intermediate image transfer belt 151. If the superimposed toner image is transported to the secondary image transfer portion TR, the sheet P is supplied to the secondary image transfer portion TR from the sheet feeding device 20 in accordance with the timing of the transport of the superimposed toner image. Moreover, the predetermined transfer voltage is applied to the backup roller 161 from the power supply device 18 controlled by the system control device 11, and multiple toner images on the intermediate image transfer belt 151 are collectively transferred to the sheet P.

Residual toner on the surface of the photoconductor drum 131 is removed by the cleaning blade 134, and is recovered by a waste toner accommodating section (not illustrated). The surface of the photoconductor drum 131 is recharged by the charging roller 132.

The fixing device 17 includes a fixing belt 17a having an endless shape that is rotated in one direction, and a pressure roller 17b that contacts with a circumferential surface of the fixing belt 17a and is rotated in one direction, and a nip portion (fixing region) is formed by a pressed region between the fixing belt 17a and the pressure roller 17b.

The sheet P, to which the toner image is transferred by the transfer unit 15, is transported to the fixing device 17 via the sheet transport device 16a in a state where the toner image is not fixed. In the sheet P transported to the fixing device 17, the toner image is fixed due to effects of pressure and heating by the pair of fixing belt 17a and the pressure roller 17b.

The sheet P, on which the fixing is finished, passes through the sheet transport device 16b, and is fed to the sheet discharging portion 30.

When an image output is performed on both surfaces of the sheet P, the front and the rear of the sheet P are reversed by the sheet transport device 16c, and the sheet is fed to the secondary image transfer portion TR in the image forming portion 10 again. Moreover, after the transfer of the toner image and the fixing of the transferred image are performed on the sheet, the sheet is fed to the sheet discharging portion 30. After the sheet P fed to the sheet discharging portion 30 is subjected to the post processing such as cutting or stapling (needle binding) as necessary, the sheet is discharged to the discharging tray.

(2) Unit Configuration and Operation of Image Forming Apparatus

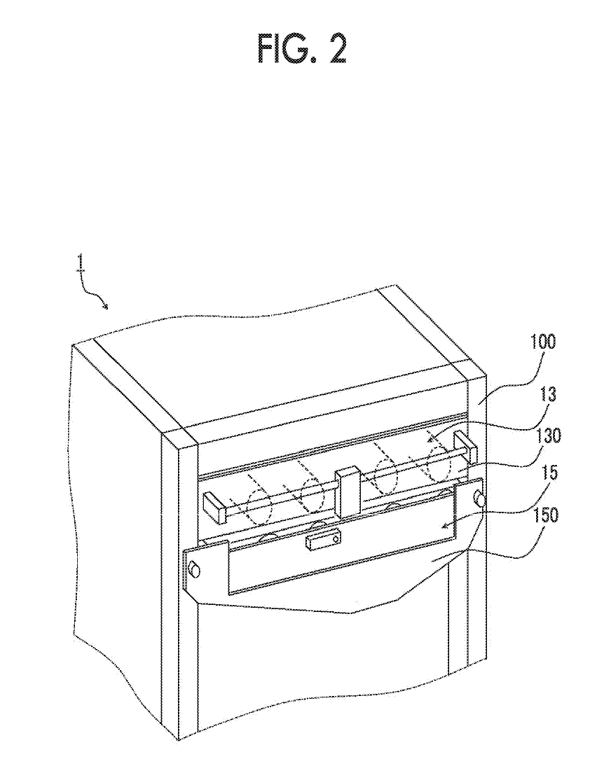

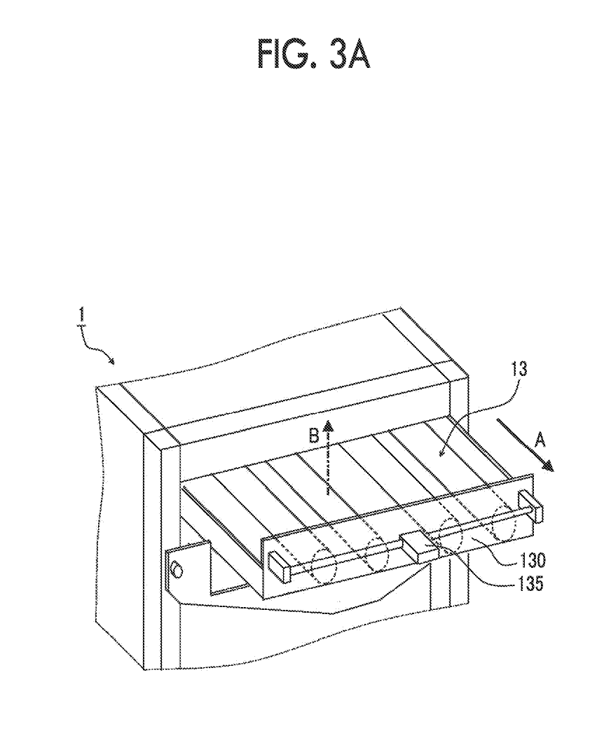

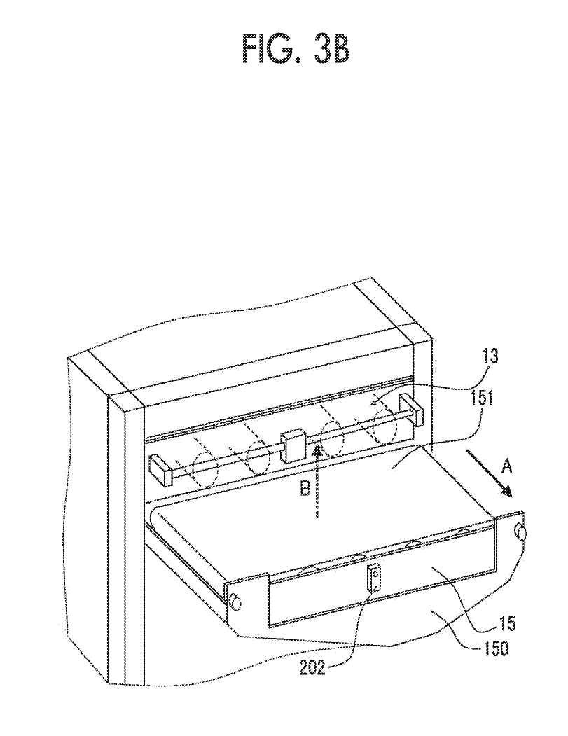

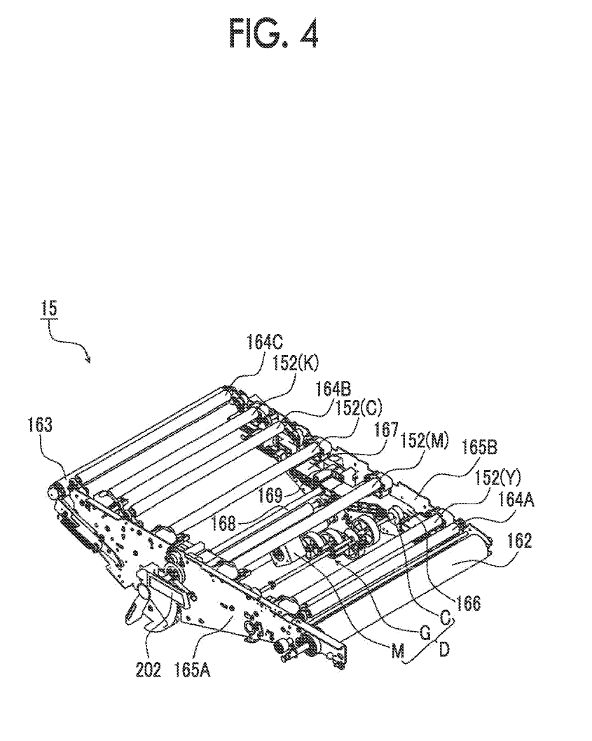

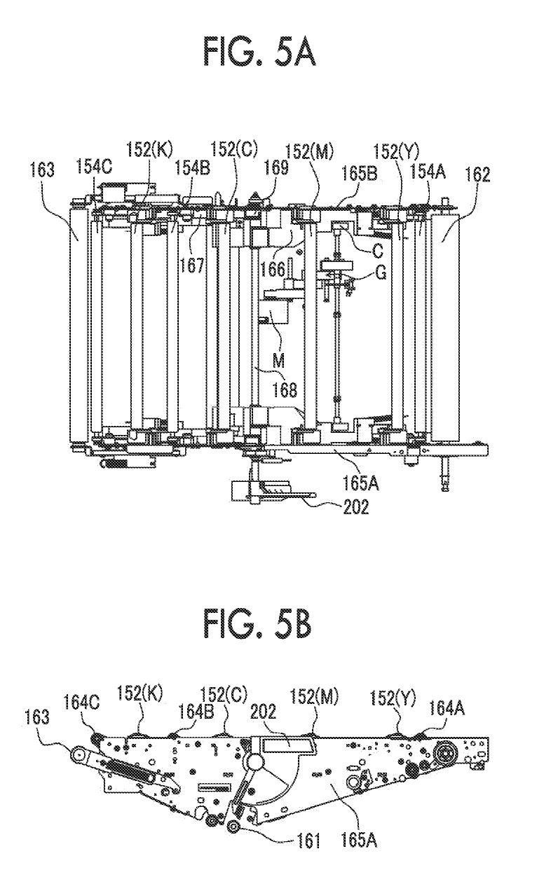

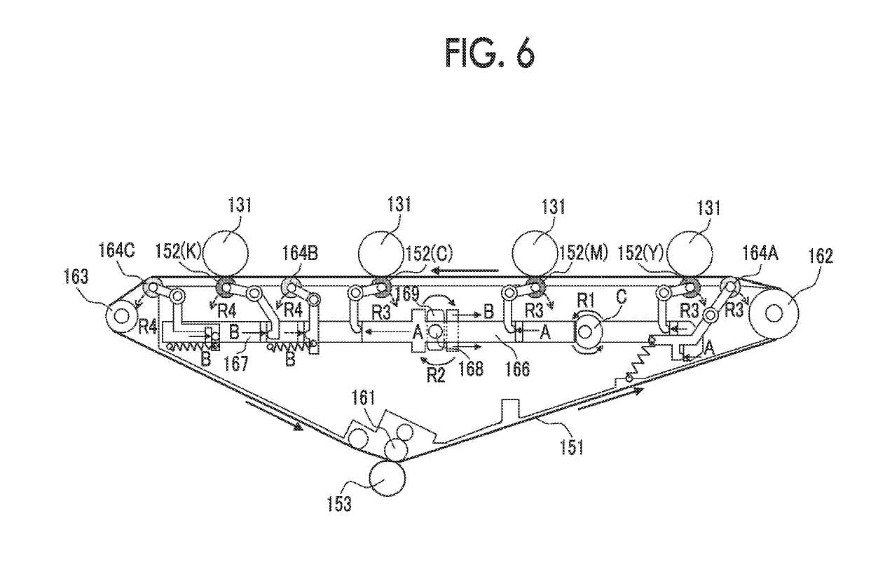

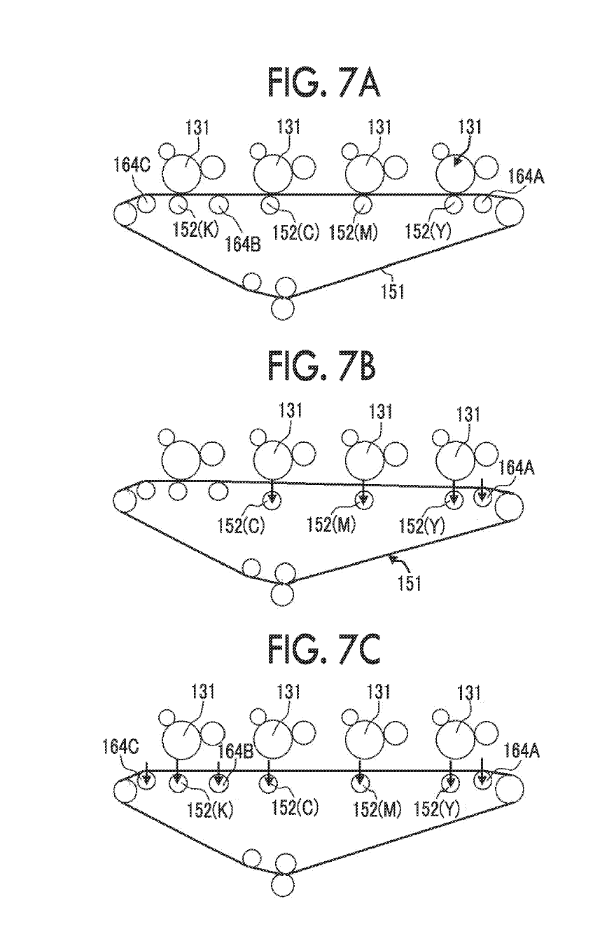

FIG. 2 is a schematic diagram for illustrating the unit configuration in the image forming apparatus 1, FIG. 3A is a schematic diagram illustrating a state where an image forming unit frame 130 is drawn from a body 100, FIG. 3B is a schematic diagram illustrating a state where a belt unit frame 150 is drawn from the body 100, FIG. 4 is a perspective view for illustrating an internal structure of the transfer unit 15, FIG. 5A is a plan view for illustrating the internal structure of the transfer unit 15, FIG. 5B is a front view for illustrating the internal structure of the transfer unit 15, FIG. 6 is a cross-sectional schematic diagram for illustrating a contacting and separating structure of the transfer unit 15, FIG. 7A is a cross-sectional schematic diagram illustrating a state where the transfer unit 15 comes into contact with the photoconductor unit 13 at the time of a full color printing, FIG. 7B is a cross-sectional schematic diagram illustrating a state where the transfer unit 15 comes into contact with the photoconductor unit 13 at the time of a monochrome printing, and FIG. 7C is a cross-sectional schematic diagram illustrating a state where the transfer unit 15 is separated from the photoconductor unit 13.

As illustrated in FIG. 2, the image forming apparatus 1 includes the image forming unit frame 130 that accommodates plural photoconductor units 13 (refer to FIG. 1), and the belt unit frame 150 that accommodates the transfer unit 15, and the image forming unit frame and the belt unit frame are accommodated and placed to be drawn from the body 100.

(2.1) Photoconductor Unit

As illustrated in FIG. 3A, the image forming unit frame 130 includes a handle 135 for drawing the image forming unit frame 130 in a direction (Y direction) orthogonal to the transport direction of the sheet P, and by the operation of the handle 135, respective photoconductor units 13 may be integrally drawn to the front side (Y direction: arrow A in drawings).

In replacement work of respective photoconductor units 13, after four photoconductor units 13 are integrally drawn to the front side (Y direction: arrow A in drawings) along with the image forming unit frame 130, attachment and detachment operations of each photoconductor unit 13 may be performed from the above (Z direction: arrow B in drawings).

(2.2) Transfer Unit

As illustrated in FIG. 3B, the belt unit frame 150 includes a handle 202 for drawing the belt unit frame 150 in the direction (Y direction) orthogonal to the transport direction of the sheet P, and after the intermediate image transfer belt 151 is separated from respective photoconductor units 13 by the rotation operation of the handle 202, the belt unit frame may be integrally drawn to the front side (Y direction: arrow A in drawings)

In the replacement work of the transfer unit 15, after the transfer unit is drawn to the front side (Y direction: arrow A in drawings) along with the belt unit frame 150, the attachment and detachment operation may be performed from the above (Z direction: arrow B in drawings).

(2.3) Contacting and Separating Structure of Transfer Unit

A contacting and separating structure of the transfer unit 15 in the image forming apparatus 1 having the above-described unit configuration will be described with reference to FIGS. 4 to 6.

As illustrated in FIGS. 4 to 5B, the transfer unit 15 is configured so that the intermediate image transfer belt 151 (not illustrated in FIGS. 4 to 5B) which is an image holding member is suspended by the plural primary image transfer rollers 152 (Y), 152 (M), 152(C), and 152 (K) that are supported by a front support plate 165A and a rear support plate 165B, the backup roller 161, a drive roller 162, a tension roller 163, a first support roller 164A, a second support roller 164B, and a third support roller 164C.

Moreover, in the transfer unit 15, a mode switching drive portion D configured of a motor M, plural gear trains G, and a cam C, and a first slide member 166 that receives power from the mode switching drive portion D and separates the color primary image transfer rollers 152(Y), 152(M), and 152(C), the first support roller 164A, and the intermediate image transfer belt 151 from the photoconductor drums 131 are supported movably to right and left (in X direction) by the rear support plate 165B.

Moreover, in the rear support plate 165B, a second slide member 167 that separates the monochrome primary image transfer roller 152(K), the second support roller 164B, the third support roller 164C, and the intermediate image transfer belt 151 from the photoconductor drums 131 is supported movably to right and left (in X direction).

Moreover, in the transfer unit 15, a cam member 169 is fixed to one end (rear support plate 165B side) of a shaft 168 that penetrates the front support plate 165A and the rear support plate 165B and is supported, and the handle 202 is provided on the other end (front support plate 165A side). According to the rotation operation of the handle 202, the first slide member 166 and the second slide member 167 are moved in a direction separate from each other, all primary image transfer rollers 152(Y), 152 (M), 152 (C), and 152 (K), the first support roller 164A, the second support roller 164B, and the third support roller 164C are separated from the photoconductor drum. 131, and thus, the transfer unit 15 may be in a state where the transfer unit is drawn from the body 100.

(2.4) Contacting and Separating Operation of Transfer Unit

(2.4.1) Full Color Printing Position

As illustrated in FIG. 6, at the time of the full color printing in which respective color toner images are formed on the intermediate image transfer belt 151, all primary image transfer rollers 152(Y), 152(M), 152(C), and 152(K) are positioned at a first contact position at which all rollers come into contact with respective photoconductor drums 131 via the intermediate image transfer belt 151.

Moreover, the first support roller 164A, the second support roller 164B, and the third support roller 164C, which support the intermediate image transfer belt 151 from the inner surface side of the intermediate image transfer belt 151, are also positioned at a position at which the intermediate image transfer belt 151 is suspended to push the photoconductor drum 131 side.

(2.4.2) Monochrome Printing Position

If the cam C receives power from the mode switching drive portion D and is rotated (arrow R1 direction in FIG. 6) from the state of the first contact position, the first slide member 166 moves in a horizontal direction (−X direction: arrow A direction in FIG. 6), and the color primary image transfer rollers 152(Y), 152(M), and 152(C) are rotated and moved (arrow R3 direction in FIG. 6) to separate from the photoconductor drums 131. In addition, the first support roller 164A is also rotated and moved (arrow R3 direction in FIG. 6) in the direction in which the intermediate image transfer belt 151 is separated from the photoconductor drums 131.

As a result, the transfer unit 15 is positioned at a second contact position that is a monochrome printing mode which is schematically illustrated in FIG. 7B.

(2.4.3) Maintenance Position

If the shaft 168 and the cam member 169 fixed to the one end (rear support plate 165B side) of the shaft 168 are rotated (arrow R2 direction in FIG. 6) by the rotation operation of the handle 202, the first slide member 166 moves in the horizontal direction (−X direction: arrow A direction in FIG. 6), and the color primary image transfer rollers 152(Y), 152(M), and 152(C), and the first support roller 164A are rotated and moved (arrow R3 direction in FIG. 6) to separate from the photoconductor drums 131.

Moreover, simultaneously, the second slide member 167 moves in the horizontal direction (X direction: arrow B direction in FIG. 6), and the monochrome primary image transfer roller 152(K), the second support roller 164B, and the third support roller 164C are rotated and moved (arrow R4 direction in FIG. 6) to separate from the photoconductor drum 131.

As a result, the transfer unit 15 is positioned at the maintenance position which is schematically illustrated in FIG. 7C, and all primary image transfer rollers 152(Y), 152(M), 152(C), and 152(K), the first support roller 164A, the second support roller 164B, and the third support roller 164C are separated from the photoconductor drums 131, and thus, the transfer unit 15 may be in the state where the transfer unit is drawn from the body 100.

In the operation of the contacting and separating of the transfer unit 15, when an operator rotates the handle 202 from the state where the transfer unit 15 is positioned at the full color printing position and the transfer unit 15 is moved to the maintenance position, all primary image transfer rollers 152(Y), 152(M), 152(C), and 152(K), the first support roller 164A, the second support roller 164B, and the third support roller 164C that are pushed to the photoconductor drum 131 side are separated from the photoconductor drums 131, and thus, a large operating force is required for the rotation operation of the handle 202.

On the other hand, when an operator rotates the handle 202 from the state where the transfer unit 15 is positioned at the monochrome printing position and the transfer unit 15 is moved to the maintenance position, only the monochrome primary image transfer roller 152(K), the second support roller 164B, and the third support roller 164C that are pushed to the photoconductor drum 131 side are separated from the photoconductor drums 131, and thus, the operating force for the rotation operation of the handle 202 is decreased compared to the case of the full color printing position.

Specifically, as one example, in the image forming apparatus 1 in the present exemplary embodiment, when the transfer unit 15 is moved from the state where the transfer unit is positioned at the full color printing position to the maintenance position, the operating force of approximate 40 N to 45 N is required. On the other hand, when the transfer unit 15 is moved from the state where the transfer unit is positioned at the monochrome printing position to the maintenance position, the operating force of approximate 30 N is sufficient to move the transfer unit.

(3) Operation and Effect of Transfer Unit

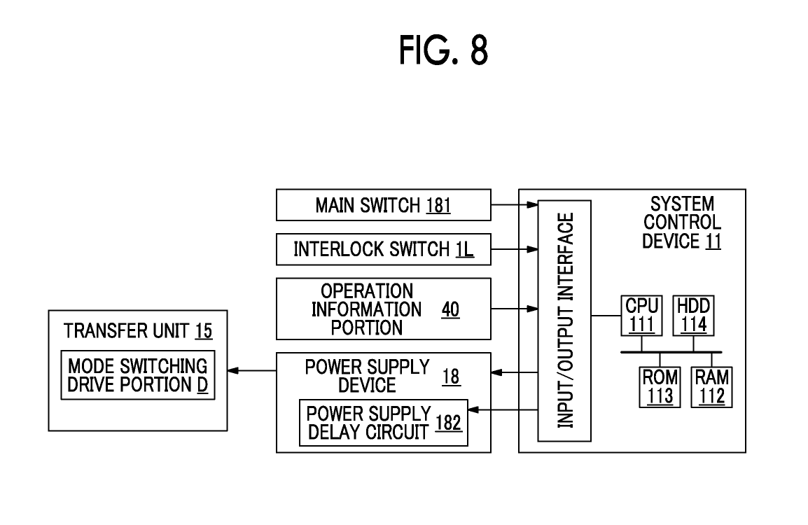

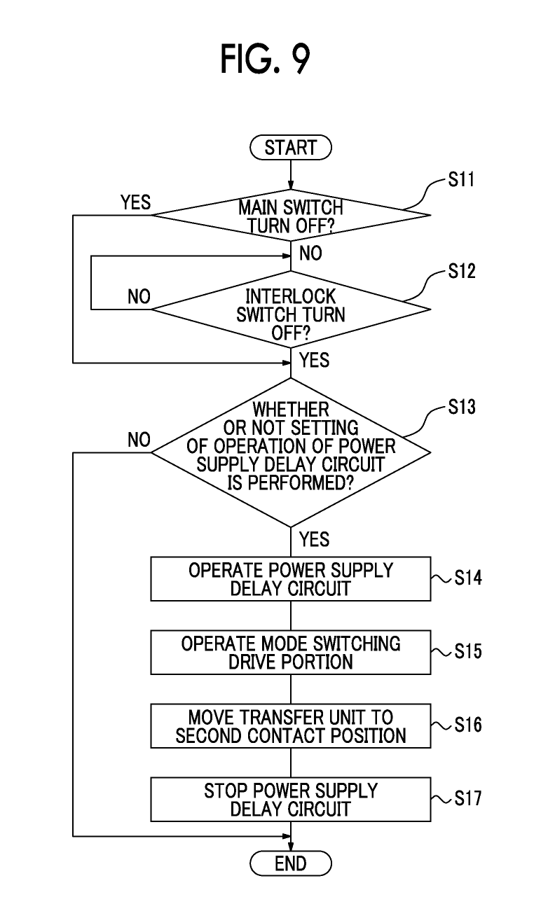

FIG. 8 is a block diagram of the mode switching drive portion, and FIG. 9 is a flowchart for illustrating the movement of the transfer unit 15 toward the maintenance position. Hereinafter, the movement and the effect of the transfer unit 15 toward the maintenance position will be described with reference to the drawings.

When an opening and closing member provided to be opened and closed to the body of the image forming apparatus 1 is opened with respect to the body of the image forming apparatus 1 or when the power supply device 18 is disconnected, the image forming apparatus 1 of the present exemplary embodiment moves to the second contact position that is the monochrome printing position when the intermediate image transfer belt 151 is positioned at the first contact position.

In addition, the operator rotates the handle 202 from the state where the transfer unit 15 is positioned at the second contact position, and may move the transfer unit 15 to the maintenance position.

(3.1) Block Configuration of Mode Switching Drive Portion

As illustrated in FIG. 8, the mode switching drive portion D may be driven by being connected to the power supply device 18 via the system control device 11 configured to combine a Central Processing Unit (CPU) 111, a Random Access Memory (RAM) 112, a Read Only Memory (ROM) 113, a Hard Disc Drive (HDD) 114, or the like.

A main switch 181 is connected to the CPU 111 via an input/output interface (I/O) IF, and the mode switching drive portion D may be driven by turning on the main switch 181.

Moreover, an interlock switch IL, the operation information portion 40, and a power supply delay circuit 182 that are provided in conjunction with opening and closing of a front cover which is the opening and closing member are connected to the CPU 111.

The power supply delay circuit 182 continuously supplies power to the motor M during a definite period of time so that the mode switching drive portion D is driven when the main switch 181 is turned off.

(3.2) Operation of Mode Switching Drive Portion

Next, the movement of the transfer unit 15 toward the maintenance position in the image forming apparatus 1 will be described with reference to FIG. 9.

When the printing operation is finished, when various maintenance is performed, or the like, it is determined whether or not the main switch 181 is turned off (S11). When the main switch 181 is turned off, the process proceeds to Step S13, and when the main switch 181 is not turned off (turned on), that is, when the main switch 181 is turned on, it is determined whether or not the interlock switch IL is turned off (S12).

When the interlock switch IL is turned off (S12: Yes), the process proceeds to Step S13, and when the interlock switch IL is not turned off (turned on), the state is maintained.

When the main switch 181 is turned off or when the interlock switch IL is turned off, it is determined whether or not the power supply delay circuit 182 is operated (S13).

When the power supply delay circuit 182 is set to be operated (S13: Yes), the power supply delay circuit 182 is operated (S14), the mode switching drive portion D is driven (S15), and the transfer unit 15 is moved to the second contact position which is the monochrome printing mode (S16). Moreover, the power supply delay circuit 182 stops (S17).

In the image forming apparatus 1 of the present exemplary embodiment, the mode switching drive portion D is driven, and a time required when the transfer unit 15 moves from the first contact position which is the full color printing mode to the second contact position which is the monochrome printing mode is approximately 1 second to 1.5 seconds, and the power supply delay circuit 182 stops in 2 seconds.

When the power supply delay circuit 182 is not set to be operated at Step S13 (S13: No), the state is maintained.

As a result, when the main switch 181 is turned off or when the front cover is opened and the interlock switch IL is turned off, the intermediate image transfer belt 151 moves to the second contact position which is the monochrome printing position. Moreover, from the state where the transfer unit 15 is positioned at the second contact position, the transfer unit 15 is moved to the maintenance position by rotation operation of the handle 202. At this time, since only the monochrome primary image transfer roller 152(K), the second support roller 164B, and the third support roller 164C that are pushed to the photoconductor drum 131 side are separated from the photoconductor drums 131, the operating force for the rotation operation of the handle 202 is decreased compared to the case of the full color printing position.

Moreover, when the transfer unit 15 is moved to the maintenance position by the rotation operation of the handle 202 from the state where the intermediate image transfer belt 151 is positioned at the second contact position and the image formation operation is finished, the operating force for the rotation operation of the handle 202 is decreased compared to the case of the full color printing position, and since the power supply delay circuit 182 is not operated, the number of times of movement of the intermediate image transfer belt 151 for performing contacting and separating to the photoconductor drums 131 may be suppressed.

In addition, a setting unit is provided, which sets whether or not the intermediate image transfer belt 151 moves to the second contact position which is the monochrome printing position when the front cover which is the opening and closing member is opened or the power supply device 18 is disconnected, and for example, it is possible to set whether or not the power supply delay circuit 182 is operated via the operation information portion 40.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an apparatus body;
an opening and closing member that is provided to be opened and closed with respect to the apparatus body; and
a toner image holding unit that is configured such that an image holding member holding toner images formed by a plurality of toner image forming units is movable between a first contact position at which the image holding member comes into contact with all toner image forming units and a second contact position at which the image holding member comes into contact with at least one of the toner image forming units,
wherein when the opening and closing member is opened with respect to the apparatus body or when a power supply supplying power to the apparatus body is disconnected, the image holding member moves to the second contact position.

2. The image forming apparatus according to claim 1, further comprising:
a power supply delay unit that continuously supplies power from the power supply during a predetermined time when the opening and closing member is opened with respect to the apparatus body or when the power supply is disconnected.

3. The image forming apparatus according to claim 2, further comprising:
a setting unit that sets whether or not the image holding member moves to the second contact position when the opening and closing member is opened with respect to the apparatus body or when the power supply is disconnected,
wherein the power supply delay unit is not operated when the image holding member is positioned at the second contact position and an image formation operation is finished.

4. The image forming apparatus according to claim 1, wherein
a time required when a toner image holding unit moves from the first contact position to the second contact position is approximately 1 second to 1.5 seconds.
